(19) United States
(12) Patent Application Publication
(10) Pub. No.: US 2020/0083506 A1
(43) Pub. Date: Mar. 12, 2020

(54) CERAMIC COATING ON SEPARATOR FOR BATTERIES

(71) Applicant: Applied Materials, Inc., Santa Clara, CA (US)

(72) Inventor: Subramanya P. HERLE, Mountain View, CA (US)

(21) Appl. No.: 16/528,274

(22) Filed: Jul. 31, 2019

Related U.S. Application Data
(60) Provisional application No. 62/728,340, filed on Sep. 7, 2018.

(51) Int. Cl. H01M 2/16; H01M 10/0525

(52) U.S. Cl. CPC H01M 2/164; H01M 10/0525; H01M 2/168; H01M 2/1686

(57) ABSTRACT

Separators, high performance electrochemical devices, such as, batteries and capacitors, including the aforementioned separators, and systems and methods for fabricating the same are provided. In at least one aspect, a separator is provided. The separator comprises a polymer substrate, capable of conducting ions, having a first surface and a second surface opposing the first surface. The separator further comprises a first ceramic-containing layer, capable of conducting ions, formed on the first surface. The first ceramic-containing layer has a thickness in a range from about 1,000 nanometers to about 5,000 nanometers. The separator further comprises a second ceramic-containing layer, capable of conducting ions, formed on the first ceramic-containing layer. The second ceramic-containing layer is a binder-free ceramic-containing layer and has a thickness in a range from about 1 nanometer to about 1,000 nanometers.

### CROSS-REFERENCE TO RELATED APPLICATIONS

This application claims benefit of U.S. provisional patent application Ser. No. 62/728,340, filed Sep. 7, 2018, which is incorporated herein by reference in its entirety.

### BACKGROUND

### Field

Aspects of the present disclosure generally relate to separators, high performance electrochemical devices, such as batteries and capacitors, including the aforementioned separators, and systems and methods for fabricating the same.

### Description of the Related Art

Fast-charging, high-capacity energy storage devices, such as capacitors and lithium-ion (Li-ion) batteries, are used in a growing number of applications, including portable electronics, medical, transportation, grid-connected large energy storage, renewable energy storage, and uninterruptible power supply (UPS).

Li-ion batteries typically include an anode electrode, a cathode electrode, and a separator positioned between the anode electrode and the cathode electrode. The separator is an electronic insulator, which provides physical and electrical separation between the cathode and the anode electrodes. The separator is typically made from micro-porous polyethylene and polyolefin. During electrochemical reactions, for example, charging and discharging, lithium ions are transported through the pores in the separator between the two electrodes via an electrolyte.

High temperature melt integrity of battery separators is a key property to ensure safety of the battery. In case of internal heat build-up due to overcharging or internal short-circuiting, or any other event that leads to an increase of the internal cell temperature, high temperature melt integrity can provide an extra margin of safety, as the separator will maintain its integrity and prevent the electrodes from contacting one another at high temperatures.

Typical separators for lithium-ion batteries are based on polymers such as polyethylene (PE) and polypropylene (PP), which are produced via melt processing techniques. These types of separators typically have poor melt integrity at high temperatures (e.g., greater than 160 degrees Celsius). This poor melt integrity also limits the type of subsequent processing that the separator can endure.

Accordingly, there is a need in the art for methods and systems, which enable subsequent processing of separators while maintaining the melt integrity of the separator.

### SUMMARY

Aspects of the present disclosure generally relate to separators, high performance electrochemical devices, such as, batteries and capacitors, including the aforementioned separators, and systems and methods for fabricating the same. In at least one aspect, a separator is provided. The separator comprises a polymer substrate, capable of conducting ions, having a first surface and a second surface opposing the first surface. The separator further comprises a first ceramic-containing layer, capable of conducting ions, formed on the first surface. The first ceramic-containing layer has a thickness in a range from about 1,000 nanometers to about 5,000 nanometers. The separator further comprises a second ceramic-containing layer, capable of conducting ions, formed on the first ceramic-containing layer. The second ceramic-containing layer is a binder-free ceramic-containing layer and has a thickness in a range from about 1 nanometer to about 1,000 nanometers.

In at least one aspect, a separator is provided. The separator comprises a porous ceramic body, capable of conducting ions, having a first surface and a second surface opposing the first surface. The porous ceramic body has a thickness in a range from about 2,000 nanometers to about 10,000 nanometers. The separator further comprises a first ceramic-containing layer, capable of conducting ions, formed on the first surface of the porous ceramic body layer. The first ceramic-containing layer is a binder-free ceramic-containing layer and has a thickness in a range from about 1 nanometer to about 1,000 nanometers. The separator further comprises a second ceramic-containing layer, capable of conducting ions, formed on the second surface of the porous ceramic body layer. The second ceramic-containing layer is a binder-free ceramic-containing layer and has a thickness in a range from about 1 nanometer to about 1,000 nanometers.

In at least one aspect, a method of forming a separator for a battery is provided. The method comprises exposing a material to be deposited over a microporous ion-conducting polymeric layer positioned in a processing region to an evaporation process. The microporous ion-conducting polymeric layer has a first ceramic-containing layer formed thereon. The method further comprises reacting the evaporated material with a reactive gas and/or plasma to deposit a second ceramic-containing layer, capable of conducting ions, on the first ceramic-containing layer. The first ceramic-containing layer has a thickness in a range from about 1,000 nanometers to about 5,000 nanometers. The second ceramic-containing layer is a binder-free ceramic-containing layer and has a thickness in a range from about 1 nanometer to about 1,000 nanometers.

In at least one aspect, a method of forming a separator for a battery is provided. The method comprises exposing a material to be deposited on a porous ceramic body positioned in a processing region to an evaporation process. The method further comprises reacting the evaporated material with a reactive gas and/or plasma to deposit a ceramic-containing layer, capable of conducting ions, on the porous ceramic body. The porous ceramic body has a thickness in a range from about 2,000 nanometers to about 10,000 nanometers. The ceramic-containing layer is a binder-free ceramic-containing layer and has a thickness in a range from about 1 nanometer to about 1,000 nanometers.

### BRIEF DESCRIPTION OF THE DRAWINGS

So that the manner in which the above-recited features of the present disclosure can be understood in detail, a more particular description of the aspects, briefly summarized above, may be had by reference to aspects, some of which are illustrated in the appended drawings. It is to be noted, however, that the appended drawings illustrate only typical aspects of this disclosure and are therefore not to be considered limiting of its scope, for the disclosure may admit to other equally effective aspects.

FIG. 1 illustrates a cross-sectional view of one aspect of a cell structure formed according to one or more aspects described herein;

FIG. 2 illustrates a cross-sectional view of a ceramic-coated separator formed according to one or more aspects described herein;

FIG. 3 illustrates a process flow chart summarizing one aspect of a method for forming a ceramic-coated separator according to aspects described herein;

FIG. 4 illustrates a cross-sectional view of a ceramic separator coated with an ultra-thin ceramic layer formed according to one or more aspects described herein;

FIG. 5 illustrates a process flow chart summarizing one aspect of a method for forming a ceramic separator according to aspects described herein;

FIG. 6 illustrates a process flow chart summarizing one aspect of a method for forming a ceramic separator according to aspects described herein; and

FIG. 7 illustrates a cross-sectional view of a ceramic separator coated with an ultra-thin ceramic layer formed according to one or more aspects described herein.

To facilitate understanding, identical reference numerals have been used, where possible, to designate identical elements that are common to the figures. It is contemplated that elements and features of one aspect may be beneficially incorporated in other aspects without further recitation.

### DETAILED DESCRIPTION

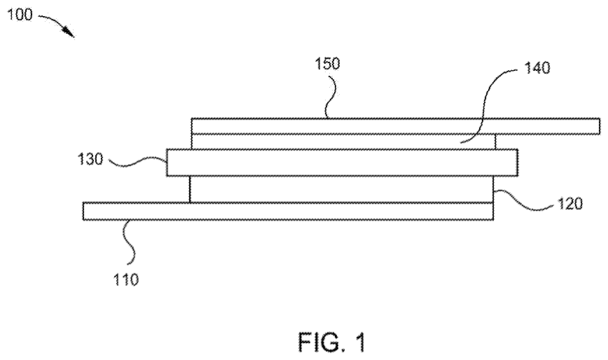

The following disclosure describes separators, high performance electrochemical cells and batteries including the aforementioned separators, systems and methods for fabricating the same. Certain details are set forth in the following description and in FIGS. 1-7 to provide a thorough understanding of various aspects of the disclosure. Other details describing well-known structures and systems often associated with electrochemical cells and batteries are not set forth in the following disclosure to avoid unnecessarily obscuring the description of the various aspects.

Many of the details, dimensions, angles and other features shown in the Figures are merely illustrative of particular aspects. Accordingly, other aspects can have other details, components, dimensions, angles and features without departing from the spirit or scope of the present disclosure. In addition, further aspects of the disclosure can be practiced without several of the details described below.

Aspects described herein will be described below in reference to a high rate evaporation process that can be carried out using a roll-to-roll coating system, such as TopMet™, SmartWeb™, and TopBeam™ all of which are available from Applied Materials, Inc. of Santa Clara, Calif. Other tools capable of performing high rate evaporation processes may also be adapted to benefit from the aspects described herein. In addition, any system enabling high rate evaporation processes described herein can be used to advantage. The apparatus description described herein is illustrative and should not be construed or interpreted as limiting the scope of the aspects described herein. It should also be understood that although described as a roll-to-roll process, the aspects described herein may be performed on discrete substrates.

As described herein, substrate can be considered to include among other things, flexible materials, films, foils, webs, strips of plastic material, metal, paper, or other materials. In addition, substrate can be considered to include a porous battery separator, an anode, or a cathode. Typically, the terms “web,” “foil,” “strip,” “substrate” and the like are used synonymously.

The currently available generation of batteries, especially Li-ion batteries, use porous polymer separators, which are susceptible to thermal shrinkage and may short-circuit between positive and negative electrodes or the corresponding current collectors. A ceramic coating on the separator helps to inhibit direct contact between electrodes and helps to prevent potential dendrite growth associated with lithium metal. Current state of the art ceramic coating is performed using wet coating (e.g., slot-die techniques) of ceramic particles dispersed in a polymeric binder to make the composite and a solvent is used to make the slurry. The thickness of the ceramic coating is normally around three microns including randomly oriented dielectric material bound together by a polymer leading to a random pore structure. The existing ceramic particle coating method has difficulty in reducing tortuosity due to this random orientation of ceramic particles. Further, it is difficult to reduce the thickness of current ceramic coatings using current wet coating methods. In order to compensate for the increased surface area of finer ceramic powder particles current wet coating methods involve increased amounts of both binder and solvent to decrease the viscosity of the slurry. Thus, the current wet coating methods suffer from several problems.

From a manufacturing standpoint, ceramic coating via dry methods is ideal from both a cost and performance point of view. However, dry methods such as physical vapor deposition (PVD) are performed at elevated processing temperatures. Elevated processing temperatures in combination with the decreasing thickness of polymer separators leads to heat induced damage such as melting or creating wrinkles in the polymer separator. In addition, thinner polymer separators often lack the mechanical integrity for current roll-to-roll processing systems.

In at least one aspect, an ultra-thin ceramic coating is formed on a slurry coated ceramic separator to improve cell safety, improve the coating uniformity of the ceramic materials, and improve the current density and blocking of lithium dendrites. Not to be bound by theory but it is believed that the columnar structure of the ultra-thin ceramic coating helps distribute the ions more uniformly, which leads to more uniform current density. In at least one aspect of the present disclosure, some benefits include a thinner and lower weight separator, which increases in cell energy density and cell charge/discharge performance. Additional benefits of some aspects include a high quality nano-porous uniform coating, which leads to uniform ion current density. In at least one aspect of the present disclosure, some benefits include an ion-conducting thin non-porous ceramic coating, which blocks lithium dendrites.

In one implementation, a computer readable medium is provided having instructions stored thereon that, when executed, causes a method of depositing an ultra-thin ceramic coating on a slurry coated ceramic separator. The method may include any implementations of the methods and systems disclosed herein.

As described herein, substrate can be considered to include among other things, flexible materials, porous polymeric materials, films, foils, webs, strips of plastic material, metal, paper, or other materials. Typically, the terms “web,” “foil,” “strip,” “substrate” and the like are used synonymously.

FIG. 1 illustrates an example of a cell structure 100 having a ceramic-coated separator according to aspects of the present disclosure. The cell structure 100 has a positive current collector 110, a positive electrode 120, a ceramic-coated separator 130, a negative electrode 140 and a negative current collector 150. Note in FIG. 1 that the current collectors are shown to extend beyond the stack, although it is not necessary for the current collectors to extend beyond the stack, the portions extending beyond the stack may be used as tabs. The cell structure 100, even though shown as a planar structure, may also be formed into a cylinder by rolling the stack of layers; furthermore, other cell configurations (e.g., prismatic cells, button cells) may be formed.

The current collectors 110, 150, on the positive electrode 120 and the negative electrode 140, respectively, can be identical or different electronic conductors. Examples of metals that the current collectors 110, 150 may be comprised of include aluminum (Al), copper (Cu), zinc (Zn), nickel (Ni), cobalt (Co), tin (Sn), silicon (Si), manganese (Mn), magnesium (Mg), alloys thereof, and combinations thereof. In at least one aspect, the current collector 110 comprises aluminum and the current collector 150 comprises copper.

The negative electrode 140 or anode may be any material compatible with the positive electrode 120. The negative electrode 140 may have an energy capacity greater than or equal to 372 mAh/g, preferably ≥700 mAh/g, and most preferably ≥1,000 mAh/g. The negative electrode 140 may be constructed from a graphite, silicon-containing graphite (e.g., silicon (<5%) blended graphite), a lithium metal foil or a lithium alloy foil (e.g. lithium aluminum alloys), or a mixture of a lithium metal and/or lithium alloy and materials such as carbon (e.g. coke, graphite), nickel, copper, tin, indium, silicon, oxides thereof, or combinations thereof.

The positive electrode 120 or cathode may be any material compatible with the anode and may include an intercalation compound, an insertion compound, or an electrochemically active polymer. Suitable intercalation materials include, for example, lithium-containing metal oxides, MoS₂, FeS₂, MnO₂, TiS₂, NbSe₃, LiCoO₂, LiNiO₂, LiMnO₂, LiMn₂O₄, V₆O₁₃ and V₂O₅. Suitable lithium-containing oxides include layered, such as lithium cobalt oxide (LiCoO₂), or mixed metal oxides, such as LiNiₓCo₁₋₂ₓMnO₂, LiNiMnCoO₂ (“NMC”), LiNi_{0.5}Mn_{1.5}O₄, Li(Ni_{0.8}Co_{0.15}Al_{0.05})O₂, LiMn₂O₄, and doped lithium rich layered-layered materials, wherein x is zero or a non-zero number. Suitable phosphates include iron olivine (LiFePO₄) and it's variants (such as LiFe₍₁₋ₓ₎MgₓPO₄), LiMoPO₄, LiCoPO₄, LiNiPO₄, Li₃V₂(PO₄)₃, LiVOPO₄, LiMP₂O₇, or LiFe_{1.5}P₂O₇, wherein x is zero or a non-zero number. Suitable fluorophosphates include LiVPO₄F, LiAlPO₄F, Li₅V(PO₄)₂F₂, Li₅Cr(PO₄)₂F₂, Li₂CoPO₄F, or Li₂NiPO₄F. Suitable silicates may be Li₂FeSiO₄, Li₂MnSiO₄, or Li₂VOSiO₄. An exemplary non-lithium compound is Na₅V₂(PO₄)₂F₃.

In at least one aspect where electrolyte is present, electrolytes infused in cell components 120, 130 and 140 can be comprised of a liquid/gel or a solid polymer and may be different in each. Any suitable electrolyte may be used. In at least one aspect, the electrolyte primarily includes a salt and a medium (e.g., in a liquid electrolyte, the medium may be referred to as a solvent; in a gel electrolyte, the medium may be a polymer matrix). The salt may be a lithium salt. The lithium salt may include, for example, LiPF₆, LiAsF₆, LiCF₃SO₃, LiN(CF₃SO₃)₃, LiBF₆, and LiClO₄, BETTE electrolyte (commercially available from 3M Corp. of Minneapolis, Minn.) and combinations thereof.

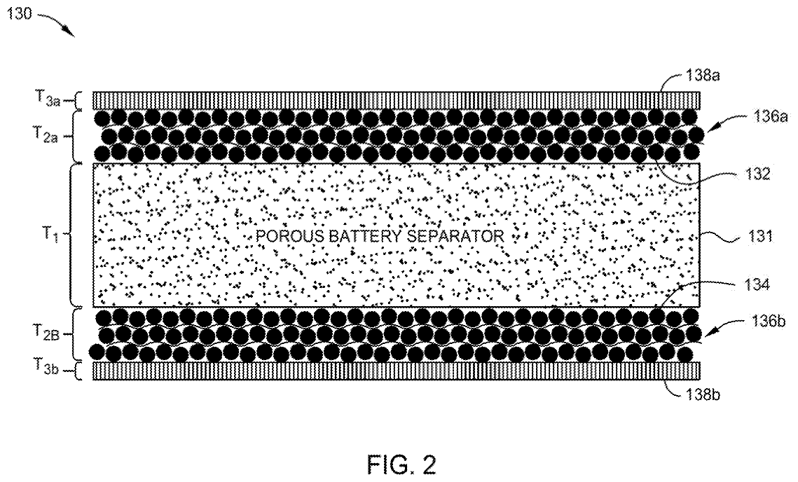

FIG. 2 illustrates a cross-sectional view of the ceramic-coated separator 130 formed according to one or more aspects described herein. In at least one aspect, the ceramic-coated separator 130 includes a porous (e.g., microporous) polymeric substrate 131 capable of conducting ions (e.g., a separator film). The porous polymeric substrate 131 has a first surface 132 and a second surface 134 opposite the first surface 132. A first ceramic-containing layer(s) 136a, 136b (collectively 136) capable of conducting ions, is formed on at least a portion of the first surface 132 of the porous polymeric substrate 131 and optionally a portion of the second surface 134 of the porous polymeric substrate 131. A second ceramic-containing layer(s) 138a, 138b (collectively 138) (e.g., ultra-thin ceramic coating), capable of conducting ions, is formed on at least a portion of the first ceramic-containing layer 136. The first ceramic-containing layer 136 has a thickness greater than a thickness of the second ceramic-containing layer 138.

In at least one aspect, the porous polymeric substrate 131 does not need to be ion-conducting, however, once filled with electrolyte (liquid, gel, solid, combination etc.); the combination of porous substrate and electrolyte is ion-conducting. The first ceramic-containing layer 136 and the second ceramic-containing layer 138 are, at least, adapted for preventing electronic shorting (e.g. direct or physical contact of the anode and the cathode) and blocking dendrite growth. The porous polymeric substrate 131 may be, at least, adapted for blocking (or shutting down) ionic conductivity (or flow) between the anode and the cathode during the event of thermal runaway. The first ceramic-containing layer 136 and the second ceramic-containing layer 138 of the ceramic-coated separator 130 should be sufficiently conductive to allow ionic flow between the anode and cathode, so that the cell structure 100 generates current in targeted quantities. As discussed herein, in at least one aspect, the second ceramic-containing layer 138 is formed on the first ceramic-containing layer 136 using evaporation techniques.

In at least one aspect, the porous polymeric substrate 131 is a microporous ion-conducting polymeric substrate. In at least one aspect, the porous polymeric substrate 131 is a multi-layer polymeric substrate. In at least one aspect, the porous polymeric substrate 131 is selected from any commercially available polymeric microporous membranes (e.g., single or multi-ply), for example, those products produced by produced by Polypore (Celgard Inc., of Charlotte, N.C.), Toray Tonen (Battery separator film (BSF)), SK Energy (lithium ion battery separator (LiBS), Evonik industries (SEPARION® ceramic separator membrane), Asahi Kasei (Hipore™ polyolefin flat film membrane), DuPont (Energain®), etc. In at least one aspect, the porous polymeric substrate 131 has a porosity in the range of 20 to 80% (e.g., in the range of 28 to 60%). In at least one aspect, the porous polymeric substrate 131 has an average pore size in the range of 0.02 to 5 microns (e.g., 0.08 to 2 microns). In at least one aspect, the porous polymeric substrate 131 has a Gurley Number in the range of 15 to 150 seconds. In some aspects, the porous polymeric substrate 131 comprises a polyolefin polymer. Examples of suitable polyolefin polymers include polypropylene, polyethylene, or combinations thereof. In at least one aspect, the porous polymeric substrate 131 is a polyolefinic membrane. In some aspect, the polyolefinic membrane is a polyethylene membrane or a polypropylene membrane.

In at least one aspect, the porous polymeric substrate 131 has a thickness “T₁” in a range from about 1 micron to about 50 microns, for example, in a range from about 3 microns to about 25 microns; in a range from about 7 microns to about 12 microns; or in a range from about 14 microns to about 18 microns.

In at least one aspect, the first ceramic-containing layer 136 and the second ceramic-containing layer 138 are formed on a substrate other than the porous polymeric substrate 131. For example, the first ceramic-containing layer 136 and the second ceramic-containing layer 138 are formed on a substrate selected from flexible materials, films, foils, webs, strips of plastic material, metal, anode materials, cathode materials, or paper. In one implementation, the first ceramic-containing layer 136 and the second ceramic-containing layer 138 are formed on a metal substrate, such as, for example, a copper substrate or an aluminum substrate. In another implementation, the first ceramic-containing layer 136 and the second ceramic-containing layer 138 are formed on a film, such as negative electrode 140 (e.g., a lithium metal film), which may be formed on current collector 150 (e.g., a copper substrate).

The first ceramic-containing layer 136 provides mechanical support and thermal protection for the porous polymeric substrate 131. It has been found by the inventors that inclusion of the first ceramic-containing layer 136 increases the melt integrity of the porous polymeric substrate 131 during processing at elevated temperatures. Thus, including the first ceramic-containing layer 136 allows for the processing of thinner separator materials at elevated temperatures.

The first ceramic-containing layer 136 includes one or more ceramic materials. The ceramic material may be an oxide. In at least one aspect, the first ceramic-containing layer 136 includes a material selected from, for example, aluminum oxide (Al₂O₃), AlOₓ, AlOₓN_{y}, AlN (aluminum deposited in a nitrogen environment), aluminum hydroxide oxide ((AlO(OH)) (e.g., diaspore ((α-AlO(OH))), boehmite (γ-AlO(OH)), or akdalaite (5Al₂O₃H₂O)), calcium carbonate (CaCO₃), titanium dioxide (TiO₂), SiS₂, SiPO₄, silicon oxide (SiO₂), zirconium oxide (ZrO₂), hafnium oxide (HfO₂), MgO, TiO₂, Ta₂O₅, Nb₂O₅, LiAlO₂, BaTiO₃, BN, ion-conducting garnet, ion-conducting perovskite, ion-conducting anti-perovskites, porous glass ceramic, and the like, or combinations thereof. In at least one aspect, the first ceramic-containing layer 136 comprises a combination of AlOₓ and Al₂O₃. In at least one aspect, the first ceramic-containing layer 136 comprises a material selected from the group comprising, consisting of, or consisting essentially of porous aluminum oxide, porous aluminum oxyhydroxide, porous-ZrO₂, porous-HfO₂, porous-SiO₂, porous-MgO, porous-TiO₂, porous-Ta₂O₅, porous-Nb₂O₅, porous-LiAlO₂, porous-BaTiO₃, ion-conducting garnet, anti-ion-conducting perovskites, porous glass dielectric, or combinations thereof. In at least one aspect, the first ceramic-containing layer 136 contains a binder material. In at least one aspect, the first ceramic-containing layer 136 is a porous aluminum oxide layer. Any suitable deposition technique, which achieves the targeted ion-conductivity, mechanical integrity, and thickness of the first ceramic-containing layer 136, may be used to form the first ceramic-containing layer 136. Suitable techniques include slurry deposition techniques or wet coating techniques such as slot-die techniques and doctor blade techniques. In at least one aspect, the first ceramic-containing layer 136 is deposited using ceramic particles dispersed in a polymeric binder to make the composite and a solvent to make the slurry. In at least one aspect, the first ceramic-containing layer 136 and the porous polymeric substrate 131 are prefabricated and supplied together.

In at least one aspect, the first ceramic-containing layer 136 includes a lithium-ion-conducting ceramic or a lithium-ion-conducting glass. The lithium-ion-conducting material may be comprised of one or more of LiPON, doped variants of either crystalline or amorphous phases of Li₇La₃Zr₂O₁₂, doped anti-perovskite compositions, Li₂S-P₂S₅, Li₂S, LiKSO₄, Li₃P, Li₅B₇S₁₃, Li₁₀GeP₂S₁₂, Li₃PS₄, LiNH₂, LiNO₃, lithium amide boro-hydride Li(BH₄)₁₋ₓ(NH₂)ₓ, lithium phosphate glasses, (1-x) Lil—(x)Li₄SnS₄, xLil—(1-x)Li₄SnS₄, mixed sulfide and oxide electrolytes (crystalline LLZO, amorphous (1-x)Lil—(x)Li₄SnS₄ mixture, and amorphous xLil—(1-x)Li₄SnS₄) for example. In at least one aspect, x is between 0 and 1 (e.g., 0.1, 0.2, 0.3, 0.4, 0.5, 0.6, 0.7, 0.8, and 0.9). The lithium-ion-conducting material can be directly deposited on the lithium metal film using either a by Physical Vapor Deposition (PVD), Chemical Vapor Deposition (CVD), spray, doctor blade, printing or any of a number of coating methods. A suitable method for some aspects is PVD. In at least one aspect, the first ceramic-containing layer 136 does not need to be ion-conducting, however, once filled with electrolyte (liquid, gel, solid, combination etc.); the combination of porous substrate and electrolyte is ion-conducting.

In at least one aspect, the first ceramic-containing layer 136 has a thickness “T₂ₐ” and “T_{2b}” (collectively T₂) in a range from about 1,000 nanometers to about 5,000 nanometers, for example, in a range from about 1,000 nanometers to about 3,000 nanometers; or in a range from about 1,000 nanometers to about 2,000 nanometers.

In at least one aspect, the first ceramic-containing layer 136 has a porosity of at least 50%, 55%, 60%, 65%, 70%, or 75% as compared to a solid film formed from the same material and a porosity up to at least 55%, 60%, 65%, 70%, 75%, or 80% as compared to a solid film formed from the same material. In at least one aspect, the first ceramic-containing layer 136 has a porosity of at least 50%, 55%, 60%, 65%, 70%, or 75% as compared to a solid film formed from the same material and a porosity up to at least 55%, 60%, 65%, 70%, 75%, or 80% as compared to a solid film formed from the same material. In at least one aspect, the first ceramic-containing layer 136 has a porosity in a range from about 50% to about 70%. In another aspect, the first ceramic-containing layer 136 has a porosity in a range from about 70% to about 80%.

In at least one aspect, the ceramic particles of the first ceramic-containing layer 136 have an average diameter of at least about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, or about 950 nm and an average diameter up to about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1,000 nm. In at least one aspect, the ceramic particles of the first ceramic-containing layer 136 have an average diameter in a range from about 200 nm to about 500 nm. In another aspect, the ceramic particles of the first ceramic-containing layer 136 have an average diameter in a range from about 500 nm to about 1,000 nm. In yet another aspect, the ceramic particles of the first ceramic-containing layer 136 have an average diameter in a range from about 50 nm to about 100 nm.

In at least one aspect, the first ceramic-containing layer 136 may comprise one or more of various forms of porosities. In at least one aspect, the ceramic particles and binder of the first ceramic-containing layer 136 form a nano-porous structure. In at least one aspect, the nano-porous structure may have a plurality of nano-pores that are sized to have an average pore size or diameter greater than about 30 nanometers (e.g., from about 30 nanometers to about 60 nanometers; or from about 40 nanometers to about 50 nanometers). In another aspect, the nano-porous structure may have a plurality of nano-pores that are sized to have an average pore size or diameter less than about 5 nanometers. In at least one aspect, the nano-porous structure has a plurality of nano-pores having a diameter ranging from about 1 nanometer to about 20 nanometers (e.g., from about 2 nanometers to about 15 nanometers; or from about 5 nanometers to about 10 nanometers). The nano-porous structure yields a significant increase in the surface area of the second ceramic-containing layer 138. The pores of the nano-porous structure can act as liquid electrolyte reservoir and provides excess surface area for ion-conductivity.

The second ceramic-containing layer 138 includes one or more ceramic materials. The ceramic material may be an oxide. In at least one aspect, the second ceramic-containing layer 138 includes a material selected from, for example, aluminum oxide (Al₂O₃), AlOₓ, AlOₓN_{y}, AlN (aluminum deposited in a nitrogen environment), aluminum hydroxide oxide ((AlO(OH)) (e.g., diaspore ((α-AlO(OH))), boehmite (γ-AlO(OH)), or akdalaite (5Al₂O₃.H₂O)), calcium carbonate (CaCO₃), titanium dioxide (TiO₂), SiS₂, SiPO₄, silicon oxide (SiO₂), zirconium oxide (ZrO₂), hafnium oxide (HfO₂), MgO, TiO₂, Ta₂O₅, Nb₂O₅, LiAlO₂, BaTiO₃, BN, ion-conducting garnet, ion-conducting perovskite, ion-conducting anti-perovskites, porous glass ceramic, and the like, or combinations thereof. In at least one aspect, the first ceramic-containing layer 136 comprises a combination of AlOₓ and Al₂O₃. In at least one aspect, the second ceramic-containing layer 138 includes a material selected from the group comprising, consisting of, or consisting essentially of porous aluminum oxide, porous aluminum oxyhydroxide, porous-ZrO₂, porous-HfO₂, porous-SiO₂, porous-MgO, porous-TiO₂, porous-Ta₂O₅, porous-Nb₂O₅, porous-LiAlO₂, porous-BaTiO₃, ion-conducting garnet, anti-ion-conducting perovskites, porous glass dielectric, or combinations thereof. The second ceramic-containing layer 138 is a binder-free dielectric layer. In at least one aspect, the second ceramic-containing layer 138 is a porous aluminum oxide layer. In at least one aspect, the second ceramic-containing layer 138 is non-porous. The second ceramic-containing layer 138 is typically deposited using evaporation techniques as described herein.

In at least one aspect, the second ceramic-containing layer 138 has a thickness “T₃ₐ” and “T_{3b}” (collectively T₃) in a range from about 1 nanometer to about 1,000 nanometers, for example, in a range from about 50 nanometers to about 500 nanometers; or in a range from about 50 nanometers to about 200 nanometers.

In at least one aspect, the second ceramic-containing layer 138 includes a plurality of ceramic columnar projections. The ceramic columnar shaped projections may have a diameter that expands from the bottom (e.g., where the columnar shaped projection contacts the porous substrate) of the columnar shaped projection to a top of the columnar shaped projection. The ceramic columnar projections typically comprise ceramic grains. Nano-structured contours or channels are typically formed between the ceramic grains.

In at least one aspect, the second ceramic-containing layer 138 may comprise one or more of various forms of porosities. In at least one aspect, the columnar projections of the second ceramic-containing layer 138 form a nano-porous structure between the columnar projections of ceramic material. In at least one aspect, the nano-porous structure may have a plurality of nano-pores that are sized to have an average pore size or diameter less than about 10 nanometers (e.g., from about 1 nanometer to about 10 nanometers; from about 3 nanometers to about 5 nanometers). In another aspect, the nano-porous structure may have a plurality of nano-pores that are sized to have an average pore size or diameter less than about 5 nanometers. In at least one aspect, the nano-porous structure has a plurality of nano-pores having a diameter ranging from about 1 nanometer to about 20 nanometers (e.g., from about 2 nanometers to about 15 nanometers; or from about 5 nanometers to about 10 nanometers). The nano-porous structure yields a significant increase in the surface area of the second ceramic-containing layer 138. The pores of the nano-porous structure can act as liquid electrolyte reservoir and provides excess surface area for ion-conductivity.

In at least one aspect, the first ceramic-containing layer 136 and the second ceramic-containing layer 138 include the same ceramic material. In another aspect, the first ceramic-containing layer 136 and the second ceramic-containing layer 138 include different ceramic materials.

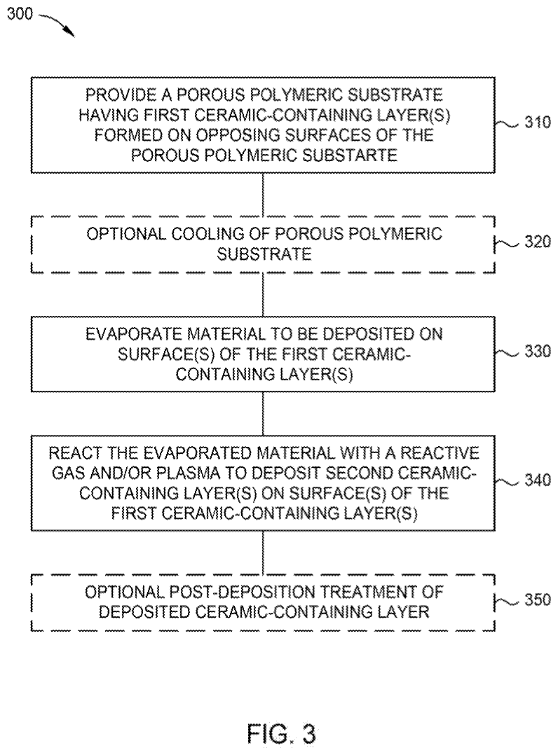

FIG. 3 illustrates a process flow chart summarizing one aspect of a method 300 for forming a ceramic-coated separator according to aspects described herein. The ceramic-coated separator may be the ceramic-coated separator 130 depicted in FIG. 1 and FIG. 2.

At operation 310, a porous polymeric substrate, such as the porous polymeric substrate 131, having first ceramic-containing layer(s), such as the first ceramic-containing layer(s) 136a, 136b, formed on opposing surfaces of the porous polymeric substrate 131, such as the first surface 132 and the opposing second surface 134 of the porous polymeric substrate 131 is provided. In at least one aspect, the first ceramic-containing layer(s) 136 and the porous polymeric substrate 131 are prefabricated and supplied together. In another aspect, the first ceramic-containing layer(s) 136 is formed on the porous polymeric substrate 131 using a wet deposition process, such as a slurry deposition process. In at least one aspect, the first ceramic-containing layer 136 and the second ceramic-containing layer 138 are formed on a substrate other than the porous polymeric substrate 131.

At operation 320, the porous polymeric substrate 131 having the first ceramic-containing layer(s) 136 formed thereon is optionally exposed to a cooling process. In at least one aspect, the porous polymeric substrate 131 may be cooled to a temperature between −20 degrees Celsius and room temperature (i.e., 20 to 22 degrees Celsius) (e.g., −10 degrees Celsius and 0 degrees Celsius). In at least one aspect, the porous polymeric substrate 131 may be cooled by cooling the processing drum over which the microporous ion-conducting polymeric substrate travels over during processing. Other active cooling means may be used to cool the microporous ion-conducting polymeric substrate. During the evaporation process, the porous polymeric substrate 131 may be exposed to temperatures in excess of 1,000 degrees Celsius thus in at least one aspect it is beneficial to cool the porous polymeric substrate 131 prior to the evaporation process of operation 330.

At operation 330, the material to be deposited on surface(s) of the first ceramic-containing layer(s) 136 is exposed to an evaporation process to evaporate the material to be deposited in a processing region. In at least one aspect, the material to be evaporated is a metal or a metal oxide. In at least one aspect, the material to be evaporated is chosen from the group of aluminum (Al), zirconium (Zr), hafnium (Hf), niobium (Nb), tantalum (Ta), titanium (Ti), yttrium (Y), lanthanum (La), silicon (Si), boron (B), silver (Ag), chromium (Cr), copper (Cu), indium (In), iron (Fe), magnesium (Mg), calcium (Ca), strontium (Sr), barium (Ba), nickel (Ni), tin (Sn), ytterbium (Yb), lithium (Li), calcium (Ca) or combinations thereof. In another aspect, the material to be evaporated is chosen from the group of zirconium oxide, hafnium oxide, silicon oxide, magnesium oxide, titanium oxide, tantalum oxide, niobium oxide, lithium aluminum oxide, barium titanium oxide, or combinations thereof. In at least one aspect, the material to be deposited is a metal such as aluminum. Further, the evaporation material may also be an alloy of two or more metals. The evaporation material is the material that is evaporated during the evaporation and with which the microporous ion-conducting polymeric substrate is coated. The material to be deposited (e.g., aluminum) can be provided in a crucible. The material to be deposited, for example, can be evaporated by thermal evaporation techniques or by electron beam evaporation techniques. In another aspect, the material to be deposited is deposited using chemical vapor deposition (CVD) or atomic layer deposition (ALD) techniques. For example, in at least one aspect, the material to be deposited is Al₂O₃, which is deposited by an ALD process. In another example, the material to be deposited is SiO₂, which is deposited by a CVD process.

In at least one aspect, the material to be evaporated is fed to the crucible as a wire. In this case, the feeding rates and/or the wire diameters are chosen such that the targeted ratio of the evaporation material and the reactive gas is achieved. In at least one aspect, the diameter of the feeding wire for feeding to the crucible is chosen between 0.5 mm and 2.0 mm (e.g., between 1.0 mm and 1.5 mm). These dimensions may refer to several feedings wires made of the evaporation material. In at least one aspect, feeding rates of the wire are in the range of between 50 cm/min and 150 cm/min (e.g., between 70 cm/min and 100 cm/min).

The crucible is heated in order to generate a vapor, which reacts with the reactive gas and/or plasma supplied at operation 340 to coat the surfaces of the first ceramic-containing layer(s) 136 with second ceramic-containing layer(s) such as the second ceramic-containing layer(s) 138. Typically, the crucible is heated by applying a voltage to the electrodes of the crucible, which are positioned at opposite sides of the crucible. Generally, according to aspects described herein, the material of the crucible is conductive. Typically, the material used as crucible material is temperature resistant to the temperatures used for melting and evaporating. Typically, the crucible of the present disclosure is made of one or more materials selected from the group comprising, consisting of, or consisting essentially of metallic boride, metallic nitride, metallic carbide, non-metallic boride, non-metallic nitride, non-metallic carbide, nitrides, titanium nitride, borides, graphite, TiB₂, BN, B₄C, and SiC.

The material to be deposited is melted and evaporated by heating the evaporation crucible. Heating can be conducted by providing a power source (not shown) connected to the first electrical connection and the second electrical connection of the crucible. For instance, these electrical connections may be electrodes made of copper or an alloy thereof. Thereby, heating is conducted by the current flowing through the body of the crucible. According to other aspects, heating may also be conducted by an irradiation heater of an evaporation apparatus or an inductive heating unit of an evaporation apparatus.

In at least one aspect, the evaporation unit is typically heatable to a temperature of between 1,300 degrees Celsius and 1,600 degrees Celsius, such as 1,560 degrees Celsius. This is done by adjusting the current through the crucible accordingly, or by adjusting the irradiation accordingly. Typically, the crucible material is chosen such that its stability is not negatively affected by temperatures of that range. Typically, the speed of the porous polymeric substrate 131 is in the range of between 20 cm/min and 200 cm/min, more typically between 80 cm/min and 120 cm/min such as 100 cm/min. In these cases, the means for transporting should be capable of transporting the substrate at those speeds.

Optionally, at operation 340, the evaporated material is reacted with a reactive gas and/or plasma to form the second ceramic-containing layer(s), such as the second ceramic-containing layer(s) 138a, 138b, on surfaces, such as the exposed surface(s) of the first ceramic-containing layer 136. According to some aspects, which can be combined with other aspects described herein, the reactive gases can be selected from the group comprising, consisting of, or consisting essentially of: oxygen-containing gases, nitrogen-containing gases, or combinations thereof. Examples of oxygen-containing gases that may be used with the aspects described herein include moist oxygen, oxygen (O₂), ozone (O₃), oxygen radicals (O*), or combinations thereof. Examples of nitrogen containing gases that may be used with the aspects described herein include N₂, N₂O, NO₂, NH₃, or combinations thereof. According to some aspects, additional gases, typically inert gases such as argon can be added to a gas mixture comprising the reactive gas. Thereby, the amount of reactive gas can be more easily controlled. According to some aspects, which can be combined with other aspects described herein, the process can be carried out in a vacuum environment with a typical atmosphere of 1*10⁻² mbar to 1*10⁻⁶ mbar (e.g., 1*10⁻³ mbar or below; 1*10⁻⁴ mbar or below).

In at least one aspect where the evaporated material is reacted with plasma, the plasma is an oxygen-containing plasma. In at least one aspect, the oxygen-containing plasma is formed from an oxygen-containing gas and optionally an inert gas. The oxygen-containing gas may be selected from the group of N₂O, moist oxygen, O₂, O₃, H₂O, and combinations thereof. The optional inert gas may be selected from the group of helium, argon, or combinations thereof. In at least one aspect, the oxygen-containing plasma is formed by a remote plasma source and delivered to the processing region to react with the evaporated material and form the second ceramic-containing layer 138. In another aspect, the oxygen-containing plasma is formed in-situ in the processing region and reacted with the evaporated material in the processing region to form the second ceramic-containing layer 138.

In at least one aspect, the evaporated material is deposited directly on the exposed surfaces of the first ceramic-containing layer(s), such as the first ceramic-containing layer(s) 136. For example, in at least one aspect, where the material to be evaporated is a metal oxide, the material to be deposited is deposited on the exposed surfaces of the first ceramic-containing layer(s) 136 without the optional reactive gas/plasma treatment of operation 340.

At operation 350, an optional post-deposition treatment of the deposited ceramic-containing layer(s) is performed. The optional post-deposition treatment may include a post-deposition plasma treatment to densify the deposited ceramic layer, additional “functionalization” processes may be performed post-deposition; for example, complete oxidation of AlOₓ to form Al₂O₃, or deposition of polymer material to enhance puncture resistance of the membrane.

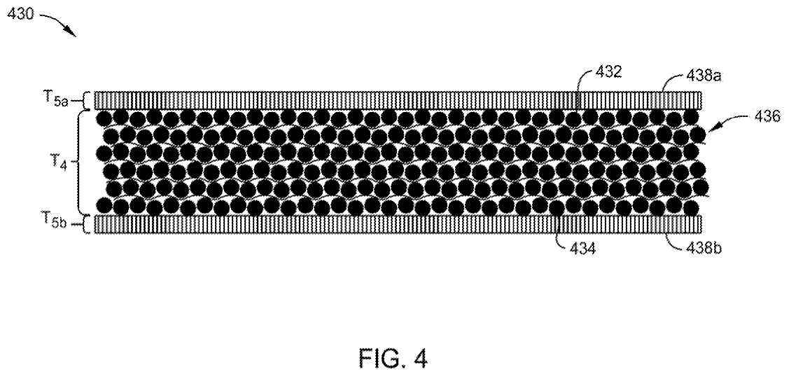

FIG. 4 illustrates a cross-sectional view of a ceramic separator 430 formed according to one or more aspects described herein. The ceramic separator may be used in place of the ceramic-coated separator 130 depicted in FIG. 1. The ceramic separator 430 includes a porous ceramic-containing body 436 capable of conducting ions (e.g., a separator film). The ceramic-containing body 436 has a first surface 432 and a second surface 434 opposite the first surface 432. A ceramic-containing layer 438a, 438b (collectively 438) (e.g., ultra-thin ceramic-containing layer) capable of conducting ions, is formed on at least a portion of the first surface 432 and optionally a portion of the second surface 434 of the porous ceramic-containing body 436. The ceramic-containing body 436 has a thickness greater than a thickness of the ceramic-containing layer(s) 438.

In at least one aspect, the porous ceramic-containing body 436 is similar to and may be formed similarly to the first ceramic-containing layer 136. In at least one aspect, the ceramic-containing body 436 has a thickness “T₄” in a range from about 1,000 nanometers to about 10,000 nanometers, for example, in a range from about 2,000 nanometers to about 6,000 nanometers; or in a range from about 2,000 nanometers to about 4,000 nanometers.

In at least one aspect, the ceramic-containing layer 438 is similar to and may be formed similarly to the second ceramic-containing layer 138. In at least one aspect, the ceramic-containing layer 438 has a thickness “T₅ₐ” and “T_{5b}” (collectively T₅) in a range from about 1 nanometer to about 2,000 nanometers, for example, in a range from about 1 nanometer to about 1,000 nanometers; in a range from about 50 nanometers to about 500 nanometers; or in a range from about 50 nanometers to about 200 nanometers.

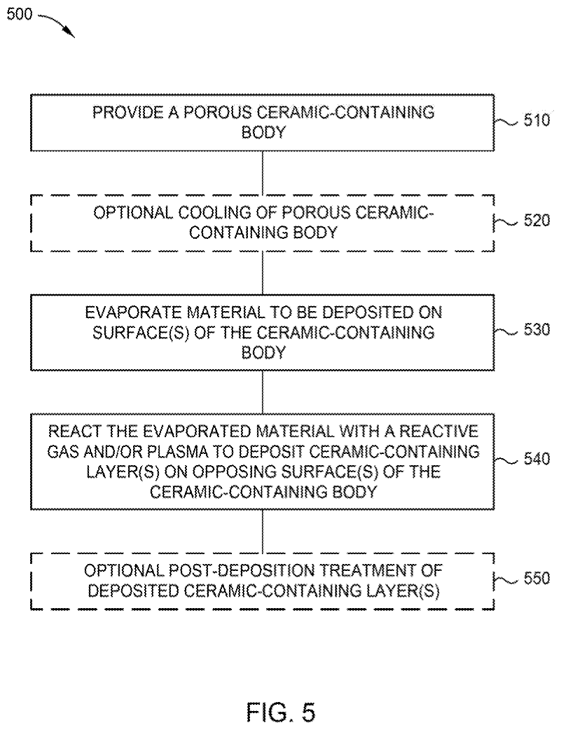

FIG. 5 illustrates a process flow chart summarizing one aspect of a method 500 for forming a ceramic separator according to aspects described herein. The ceramic separator may be the ceramic separator 430 depicted in FIG. 4.

At operation 510, a porous ceramic-containing body 436 is provided. The porous ceramic-containing body 436 may be formed similarly to the first ceramic-containing layer(s) 136. In at least one aspect, the porous ceramic-containing body 436 is prefabricated. In another aspect, the porous ceramic-containing body 436 is formed using a wet deposition process, such as a slurry deposition process. The porous ceramic-containing body 436 has a first surface 432 and a second surface 434 opposing the first surface 432. In at least one aspect, method 500 is performed on a substrate other than the porous ceramic-containing body 436.

At operation 520, the porous ceramic-containing body 436 is optionally exposed to a cooling process. In at least one aspect, the porous ceramic-containing body 436 may be cooled to a temperature between −20 degrees Celsius and room temperature (i.e., 20 to 22 degrees Celsius) (e.g., −10 degrees Celsius and 0 degrees Celsius). In at least one aspect, the porous ceramic-containing body 436 may be cooled by cooling the processing drum over which the porous ceramic-containing body 436 travels during processing. Other active cooling means may be used to cool the porous ceramic-containing body 436. During the evaporation process, the porous ceramic-containing body 436 may be exposed to temperatures in excess of 1,000 degrees Celsius thus it is beneficial to cool the porous ceramic-containing body 436 prior to the evaporation process of operation 530.

At operation 530, the material to be deposited on opposing surfaces of the porous ceramic-containing body 436, such as the first surface 432 and the second surface 434, is exposed to an evaporation process to evaporate the material to be deposited in a processing region. The evaporation process may be performed similarly to the evaporation process of operation 330. In at least one aspect, the material to be evaporated is a metal or a metal oxide. In at least one aspect, the material to be evaporated is chosen from the group of aluminum (Al), zirconium (Zr), hafnium (Hf), niobium (Nb), tantalum (Ta), titanium (Ti), yttrium (Y), lanthanum (La), silicon (Si), boron (B), silver (Ag), chromium (Cr), copper (Cu), indium (In), iron (Fe), magnesium (Mg), calcium (Ca), strontium (Sr), barium (Ba), nickel (Ni), tin (Sn), ytterbium (Yb), lithium (Li), calcium (Ca) or combinations thereof. In another aspect, the material to be evaporated is chosen from the group of zirconium oxide, hafnium oxide, silicon oxide, magnesium oxide, titanium oxide, tantalum oxide, niobium oxide, lithium aluminum oxide, barium titanium oxide, or combinations thereof. In at least one aspect, the material to be deposited is a metal such as aluminum. Further, the evaporation material may also be an alloy of two or more metals. The evaporation material is the material that is evaporated during the evaporation and with which the microporous ion-conducting polymeric substrate is coated. The material to be deposited (e.g., aluminum) can be provided in a crucible. The material to be deposited, for example, can be evaporated by thermal evaporation techniques or by electron beam evaporation techniques. In another aspect, the material to be deposited is deposited using chemical vapor deposition (CVD) or atomic layer deposition (ALD) techniques. For example, in at least one aspect, the material to be deposited is Al₂O₃, which is deposited by an ALD process. In another example, the material to be deposited is SiO₂, which is deposited by a CVD process.

At operation 540, the evaporated material is reacted with a reactive gas and/or plasma to form the ceramic-containing layer(s), such as the ceramic-containing layer(s) 438a, 438b, on surfaces, such as the exposed surface(s) of the porous ceramic-containing body 436. In at least one aspect, the ceramic-containing layer(s) are porous. In another aspect, the ceramic-containing layer(s) are non-porous. Operation 540 may be performed similarly to operation 340. According to some aspects, which can be combined with other aspects described herein, the reactive gases can be selected from the group comprising, consisting of, or consisting essentially of: oxygen-containing gases, nitrogen-containing gases, or combinations thereof. Examples of oxygen-containing gases that may be used with the aspects described herein include moist oxygen, oxygen (O₂), ozone (O₃), oxygen radicals (O*), or combinations thereof. Examples of nitrogen containing gases that may be used with the aspects described herein include N₂, N₂O, NO₂, NH₃, or combinations thereof. According to some aspects, additional gases, typically inert gases such as argon can be added to a gas mixture comprising the reactive gas. Thereby, the amount of reactive gas can be more easily controlled. According to some aspects, which can be combined with other aspects described herein, the process can be carried out in a vacuum environment with a typical atmosphere of 1*10⁻² mbar to 1*10⁻⁶ mbar (e.g., 1*10⁻³ mbar or below; 1*10⁻⁴ mbar or below).

In at least one aspect, the evaporated material is deposited directly on the exposed surfaces of the porous ceramic-containing body 436. For example, in at least one aspect, where the material to be evaporated is a metal oxide, the material to be deposited is deposited on the exposed surfaces of the porous ceramic-containing body 436 without the optional reactive gas/plasma treatment of operation 540.

At operation 550, an optional post-deposition treatment of the deposited ceramic-containing layer(s) is performed. The optional post-deposition treatment may include a post-deposition plasma treatment to densify the deposited ceramic layer, additional “functionalization” processes may be performed post-deposition; for example, complete oxidation of AlOₓ to form Al₂O₃, or deposition of polymer material to enhance puncture resistance of the membrane.

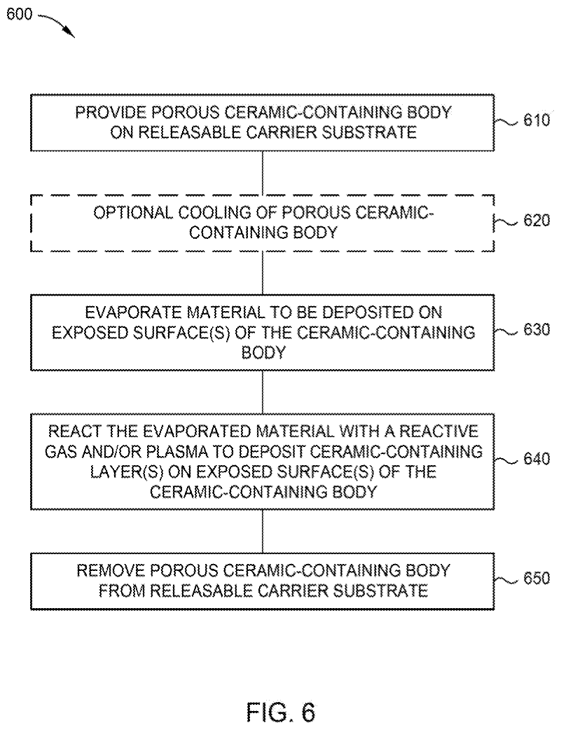

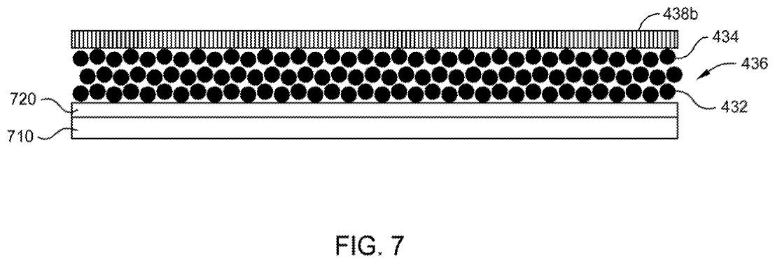

FIG. 6 illustrates a process flow chart summarizing one aspect of a method 600 for forming a ceramic separator according to aspects described herein. FIG. 7 illustrates a cross-sectional view of a ceramic separator coated with an ultra-thin ceramic layer formed according to one or more aspects described herein. The ceramic separator may be the ceramic separator 430 depicted in FIG. 4. In at least one aspect, the method 600 is performed similarly to the method 500 except that the ceramic separator is formed on a releasable carrier substrate.

At operation 610, a porous ceramic-containing body is provided on a releasable carrier substrate. The porous ceramic-containing body may be the porous ceramic-containing body 436. The releasable carrier substrate may be releasable carrier substrate 710 as shown in FIG. 7. The porous ceramic-containing body 436 may be formed on the releasable carrier substrate 710 similarly to the first ceramic-containing layer(s) 136. In at least one aspect, the porous ceramic-containing body 436 and the releasable carrier substrate 710 are prefabricated and supplied together. In another aspect, the porous ceramic-containing body 436 is formed on the releasable carrier substrate 710 using a wet deposition process, such as a slurry deposition process. The porous ceramic-containing body 436 has a first surface 432, which contacts the releasable carrier substrate 710, and a second surface 434 opposing the first surface 432. In at least one aspect, method 600 is performed on a substrate other than the porous ceramic-containing body 436.

In at least one aspect, the releasable carrier substrate 710 is a web carrier substrate. In at least one aspect, the web carrier substrate has a substantially smooth surface. Because the web carrier supports continuous fabrication of the electrode laminate through a series of deposition reactors, it should withstand high temperatures and wide pressure ranges. Examples of suitable web materials include plastics such as polyethylene terephthalate (PET), polypropylene, polyethylene, polyvinylchloride (PVC), polyolefin, and polyimides. The web carrier should have a thickness and tensile strength suitable for web handling at the line speeds dictated by the metal and glass or polymer deposition steps. The web carrier substrate has a thickness and tensile strength suitable for web handling at the speeds dictated by the deposition process.

In at least one aspect, a thin layer of a release agent 720 is formed on the releasable carrier substrate 710. Suitable release agents are known in the art. In aspects where the release agent is present, the porous ceramic-containing body 436 is formed on the release agent.

Optionally, at operation 620, the porous ceramic-containing body is exposed to a cooling process. The cooling process of operation 620 is performed similarly to the cooling process of operation 520.

At operation 630, the material to be deposited on the exposed surface(s) of the porous ceramic-containing body 436, such as the second surface 434, is exposed to an evaporation process to evaporate the material to be deposited in a processing region. At operation 640, the evaporated material is reacted with a reactive gas and/or plasma to form the ceramic-containing layer(s), such as the ceramic-containing layer(s) 438b, on surfaces, such as the exposed surface(s) of the porous ceramic-containing body 436. Operation 630 and operation 640 may be performed similarly to operation 530 and operation 540 respectively.

At operation 650, the porous ceramic-containing body having the ceramic-containing layer formed thereon is removed from the releasable carrier substrate 710. In at least one aspect, after removal from the releasable carrier substrate 710, operations 630 and 640 may be repeated to form a ceramic-containing layer, such as the ceramic-containing layer 438a on the exposed surface(s), such as the first surface 432 to form a ceramic separator similar to the ceramic separator 430 depicted in FIG. 4. The deposited ceramic-containing layers may be exposed to a post-deposition treatment process such as the post-deposition process of operation 550.

The methods 300, 500, and 600 as described herein may be executed by a controller coupled with various components of a processing chamber and/or system to control the operation thereof. The controller may include a central processing unit (CPU), memory, and support circuits. The controller may control the apparatus and/or system directly, or via computers (or controllers) associated with particular process chamber and/or support system components. The controller may be one of any form of general-purpose computer processor that can be used in an industrial setting for controlling various chambers and sub-processors. The memory, or computer readable medium, of the controller may be one or more of readily available memory such as random access memory (RAM), read only memory (ROM), floppy disk, hard disk, optical storage media (e.g., compact disc or digital video disc), flash drive, or any other form of digital storage, local or remote. The support circuits may be coupled to a CPU for supporting the processor in a conventional manner. These circuits include cache, power supplies, dock circuits, input/output circuitry and subsystems, and the like. The methods as described herein may be stored in the computer readable medium or memory as software routine that may be executed or invoked to control the operation of a system and/or processing chamber in the manner described herein. The software routine may also be stored and/or executed by a second CPU (not shown) that is remotely located from the hardware being controlled by the CPU.

Aspects:

Clause 1. A separator, comprising a polymer substrate, capable of conducting ions, having a first surface and a second surface opposing the first surface, a first ceramic-containing layer, capable of conducting ions, formed on the first surface, wherein the first ceramic-containing layer has a thickness in a range from about 1,000 nanometers to about 5,000 nanometers, and a second ceramic-containing layer, capable of conducting ions, formed on the first ceramic-containing layer, wherein the second ceramic-containing layer is a binder-free ceramic-containing layer and has a thickness in a range from about 1 nanometer to about 1,000 nanometers.

Clause 2. The separator of clause 1, further comprising a third ceramic-containing layer, capable of conducting ions, formed on the second surface, wherein the third ceramic-containing layer has a thickness in a range from about 1,000 nanometers to about 5,000 nanometers, and a fourth ceramic-containing layer, capable of conducting ions, formed on the third ceramic-containing layer, wherein the second ceramic-containing layer is a binder-free ceramic-containing layer and has a thickness in a range from about 1 nanometer to about 1,000 nanometers.

Clause 3. The separator of clause 1 or 2, wherein the first ceramic-containing layer and the third ceramic-containing layer comprise ceramic particles dispersed in a polymeric binder.

Clause 4. The separator of any of clauses 1 to 3, wherein the first ceramic-containing layer has an average pore diameter in a range from about 30 nanometer to about 60 nanometers and the second ceramic-containing layer has an average pore diameter in a range from about 30 nanometer to about 60 nanometers.

Clause 5. The separator of any of clauses 1 to 4, wherein the polymer substrate is a microporous ion-conducting polymeric layer.

Clause 6. The separator of any of clauses 1 to 5, wherein the first ceramic-containing layer and the second ceramic-containing layer each independently comprise a material selected from the group of: porous aluminum oxide, porous aluminum oxyhydroxide, porous-ZrO₂, porous-HfO₂, porous-SiO₂, porous-MgO, porous-TiO₂, porous-Ta₂O₅, porous-Nb₂O₅, porous-LiAlO₂, porous-BaTiO₃, ion-conducting garnet, anti-ion-conducting perovskites, porous glass dielectric, or combinations thereof.

Clause 7. The separator of any of clauses 1 to 6, wherein the first ceramic-containing layer comprises a binder.

Clause 8. The separator of any of clauses 1 to 7, wherein the second ceramic-containing layer has a thickness in the range from about 50 nanometers to about 500 nanometers.

Clause 9. The separator of any of clauses 1 to 8, wherein the first ceramic-containing layer has a thickness in the range from about 1,000 nanometers and 2,000 nanometers.

Clause 10. The separator of any of clauses 1 to 9, wherein the polymer substrate has a thickness in a range from about 3 microns to about 25 microns.

Clause 11. The separator of any of clauses 1 to 10, wherein the polymer substrate has a thickness in a range of about 3 microns to about 12 microns.

Clause 12. The separator of any of clauses 1 to 11, wherein the polymer substrate is a polyolefinic membrane.

Clause 13. The separator of any of clauses 1 to 12, wherein the polyolefinic membrane is a polyethylene membrane or a polypropylene membrane.

Clause 14. The separator of any of clauses 1 to 13, wherein the second ceramic-containing layer comprises porous aluminum oxide.

Clause 15. The separator of any of clauses 1 to 14, wherein the second ceramic-containing layer further comprises zirconium oxide, silicon oxide, or combinations thereof.

Clause 16. A battery comprising an anode containing at least one of lithium metal, lithium-alloy, graphite, silicon-containing graphite, nickel, copper, tin, indium, silicon, or combinations thereof, a cathode, and a separator according to any of clauses 1-15 disposed between the anode and the cathode.

Clause 17. The battery of clause 16, further comprising an electrolyte in ionic communication with the anode and the cathode via the separator.

Clause 18. The battery of clause 16 or 17, further comprising a positive current collector contacting the cathode and a negative current collector contacting the anode, wherein the positive current collector and the negative current collector are each independently comprises materials selected from aluminum (Al), copper (Cu), zinc (Zn), nickel (Ni), cobalt (Co), tin (Sn), silicon (Si), manganese (Mn), magnesium (Mg), alloys thereof, and combinations thereof.

Clause 19. A separator, comprising a porous ceramic body, capable of conducting ions, having a first surface and a second surface opposing the first surface, wherein the porous ceramic body has a thickness in a range from about 2,000 nanometers to about 10,000 nanometers, a first ceramic-containing layer, capable of conducting ions, formed on the first surface of the porous ceramic body, wherein the first ceramic-containing layer is a binder-free ceramic-containing layer and has a thickness in a range from about 1 nanometer to about 1,000 nanometers, and a second ceramic-containing layer, capable of conducting ions, formed on the second surface of the porous ceramic body layer, wherein the second ceramic-containing layer is a binder-free ceramic-containing layer and has a thickness in a range from about 1 nanometer to about 1,000 nanometers.

Clause 20. The separator of clause 19, wherein the porous ceramic body comprises ceramic particles dispersed in a polymeric binder.

Clause 21. The separator of clause 19 or 20, wherein the first ceramic-containing layer has an average pore diameter in a range from about 30 nanometer to about 60 nanometers and the second ceramic-containing layer has an average pore diameter in a range from about 30 nanometer to about 60 nanometers.

Clause 22. The separator of any of clauses 19 to 21, wherein the first ceramic-containing layer and the second ceramic-containing layer each independently comprise a material selected from the group of: porous aluminum oxide, porous aluminum oxyhydroxide, porous-ZrO₂, porous-HfO₂, porous-SiO₂, porous-MgO, porous-TiO₂, porous-Ta₂O₅, porous-Nb₂O₅, porous-LiAlO₂, porous-BaTiO₃, ion-conducting garnet, anti-ion-conducting perovskites, porous glass dielectric, or combinations thereof.

Clause 23. The separator of any of clauses 19 to 22, wherein the first and second ceramic-containing layer each independently have a thickness in the range from about 50 nanometers to about 500 nanometers.

Clause 24. The separator of any of clauses 19 to 23, wherein the first and second ceramic-containing layer each comprise porous aluminum oxide.

Clause 25. The separator of any of clauses 19 to 24, wherein the first and second ceramic-containing layer each further comprise zirconium oxide, silicon oxide, or combinations thereof.

Clause 26. A battery comprising an anode containing at least one of lithium metal, lithium-alloy, graphite, silicon-containing graphite, nickel, copper, tin, indium, silicon, or combinations thereof, a cathode, and a separator according to any of clauses 19-25 disposed between the anode and the cathode.

Clause 27. The battery of clause 26, further comprising an electrolyte in ionic communication with the anode and the cathode via the separator.

Clause 28. The battery of clause 26 or 27, further comprising a positive current collector contacting the cathode, and a negative current collector contacting the anode, wherein the positive current collector and the negative current collector are each independently comprises materials selected from aluminum (Al), copper (Cu), zinc (Zn), nickel (Ni), cobalt (Co), tin (Sn), silicon (Si), manganese (Mn), magnesium (Mg), alloys thereof, and combinations thereof.

Clause 29. A method of forming a separator for a battery, comprising exposing a material to be deposited over a microporous ion-conducting polymeric layer having a first ceramic-containing layer formed thereon and positioned in a processing region to an evaporation process, and reacting evaporated material with a reactive gas and/or plasma to deposit a second ceramic-containing layer, capable of conducting ions, on the first ceramic-containing layer, wherein the first ceramic-containing layer has a thickness in a range from about 1,000 nanometers to about 5,000 nanometers, and wherein the second ceramic-containing layer is a binder-free ceramic-containing layer and has a thickness in a range from about 1 nanometer to about 1,000 nanometers.

Clause 30. The method of clause 29, wherein the first ceramic-containing layer and the second ceramic-containing layer each independently comprise a material selected from the group of: porous aluminum oxide, porous-ZrO₂, porous-HfO₂, porous-SiO₂, porous-MgO, porous-TiO₂, porous-Ta₂O₅, porous-Nb₂O₅, porous-LiAlO₂, porous-BaTiO₃, ion-conducting garnet, anti-ion-conducting perovskites, porous glass dielectric, or combinations thereof.

Clause 31. The method of clause 29 or 30, wherein the first ceramic-containing layer comprises a binder.

Clause 32. The method of any of clauses 29 to 31, wherein the material to be deposited is a metallic material selected from the group of: aluminum (Al), silver (Ag), chromium (Cr), copper (Cu), indium (In), iron (Fe), magnesium (Mg), nickel (Ni), silicon (Si), tin (Sn), ytterbium (Yb), zirconium (Zr), or combinations thereof.

Clause 33. The method of any of clauses 29 to 32, wherein the material to be deposited is a metal oxide selected from the group of: zirconium oxide, hafnium oxide, silicon oxide, magnesium oxide, titanium oxide, tantalum oxide, niobium oxide, lithium aluminum oxide, barium titanium oxide, or combinations thereof.

Clause 34. The method of any of clauses 29 to 33, wherein the reactive gas is an oxygen-containing gas selected from the group of: oxygen (O₂), ozone (O₃), oxygen radicals (O*), or combinations thereof.

Clause 35. The method of any of clauses 29 to 34, wherein the plasma is an oxygen-containing plasma.

Clause 36. The method of any of clauses 29 to 35, wherein the second ceramic-containing layer is aluminum oxide.

Clause 37. The method of any of clauses 29 to 36, wherein the evaporation process is a thermal evaporation process or an electron beam evaporation process.

Clause 38. The method of any of clauses 29 to 37, further comprising exposing the microporous ion-conducting polymeric layer to a cooling process prior to exposing the evaporated material to be deposited to the evaporation process.

Clause 39. The method of any of clauses 29 to 38, wherein the cooling process cools the microporous ion-conducting polymeric layer to a temperature between −20 degrees Celsius and 22 degrees Celsius.

Clause 40. The method of any of clauses 29 to 39, wherein the cooling process cools the microporous ion-conducting polymeric layer to a temperature between −10 degrees Celsius and 0 degrees Celsius.

Clause 41. The method of any of clauses 29 to 40, wherein the evaporation process comprises exposing the material to be deposited to a temperature of between 1,300 degrees Celsius and 1,600 degrees Celsius.

Clause 42. The method of any of clauses 29 to 41, wherein the microporous ion-conducting polymeric comprises polyethylene or polypropylene.

In summary, some of the benefits of the present disclosure include the efficient formation of a thin ceramic separator stack. The thin ceramic separator stack includes an ultra-thin ceramic coating formed on a first side of a thicker ceramic coating, which suppresses thermal shrinkage while maintaining the targeted ionic conductivity. Additionally, not to be bound by theory but it is believed that the structure of the ultra-thin ceramic coating helps distribute the ions more uniformly, which leads to more uniform current density. The ultra-thin ceramic coating may be deposited using PVD techniques at elevated temperatures. In at least one aspect where a thin polymer separator is present, the thick ceramic coating is formed on the thin polymer separator, which provides mechanical stability while maintaining the targeted ionic conductivity. Thus, the thin polymer separator stack includes the benefit of reduced thermal shrinkage with improved mechanical stability while maintaining targeted ionic conductivity at a decreased separator thickness (e.g., 12 microns or less).

When introducing elements of the present disclosure or exemplary aspects or aspect(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to aspects of the present disclosure, other and further aspects of the disclosure may be devised without departing from the basic scope thereof, and the scope thereof is determined by the claims that follow.

1. A separator, comprising:
a polymer substrate, capable of conducting ions, having a first surface and a second surface opposing the first surface;
a first ceramic-containing layer, capable of conducting ions, formed on the first surface, wherein the first ceramic-containing layer has a thickness in a range from about 1,000 nanometers to about 5,000 nanometers; and
a second ceramic-containing layer, capable of conducting ions, formed on the first ceramic-containing layer, wherein the second ceramic-containing layer is a binder-free ceramic-containing layer and has a thickness in a range from about 1 nanometer to about 1,000 nanometers.

2. The separator of claim 1, further comprising:
a third ceramic-containing layer, capable of conducting ions, formed on the second surface, wherein the third ceramic-containing layer has a thickness in a range from about 1,000 nanometers to about 5,000 nanometers; and
a fourth ceramic-containing layer, capable of conducting ions, formed on the third ceramic-containing layer, wherein the second ceramic-containing layer is a binder-free ceramic-containing layer and has a thickness in a range from about 1 nanometer to about 1,000 nanometers.

3. The separator of claim 2, wherein the first ceramic-containing layer and the third ceramic-containing layer comprise ceramic particles dispersed in a polymeric binder.

4. The separator of claim 1, wherein the first ceramic-containing layer has an average pore diameter in a range from about 30 nanometer to about 60 nanometers and the second ceramic-containing layer has an average pore diameter in a range from about 30 nanometer to about 60 nanometers.

5. The separator of claim 1, wherein the polymer substrate is a microporous ion-conducting polymeric layer.

6. The separator of claim 2, wherein the first ceramic-containing layer and the second ceramic-containing layer each independently comprise a material selected from porous aluminum oxide, porous aluminum oxyhydroxide, porous-ZrO₂, porous-HfO₂, porous-SiO₂, porous-MgO, porous-TiO₂, porous-Ta₂O₅, porous-Nb₂O₅, porous-LiAlO₂, porous-BaTiO₃, ion-conducting garnet, anti-ion-conducting perovskites, porous glass dielectric, or combinations thereof.

7. The separator of claim 6, wherein the first ceramic-containing layer comprises a binder.

8. The separator of claim 1, wherein the second ceramic-containing layer has a thickness in the range from about 50 nanometers to about 500 nanometers.

9. The separator of claim 8, wherein the first ceramic-containing layer has a thickness in the range from about 1,000 nanometers and 2,000 nanometers.

10. The separator of claim 9, wherein the polymer substrate has a thickness in a range from about 3 microns to about 25 microns.

11. The separator of claim 10, wherein the polymer substrate has a thickness in a range of about 3 microns to about 12 microns.

12. The separator of claim 1, wherein the polymer substrate is a polyolefinic membrane.

13. The separator of claim 12, wherein the polyolefinic membrane is a polyethylene membrane or a polypropylene membrane.

14. The separator of claim 1, wherein the second ceramic-containing layer comprises porous aluminum oxide.

15. The separator of claim 14, wherein the second ceramic-containing layer further comprises zirconium oxide, silicon oxide, or combinations thereof.

16. A battery comprising:
an anode containing at least one of lithium metal, lithium-alloy, graphite, silicon-containing graphite, nickel, copper, tin, indium, silicon, or combinations thereof;
a cathode; and
a separator according to claim 1 disposed between the anode and the cathode.

17. The battery of claim 16, further comprising:
an electrolyte in ionic communication with the anode and the cathode via the separator.

18. The battery of claim 16, further comprising:
a positive current collector contacting the cathode; and
a negative current collector contacting the anode, wherein the positive current collector and the negative current collector are each independently comprises materials selected from aluminum (Al), copper (Cu), zinc (Zn), nickel (Ni), cobalt (Co), tin (Sn), silicon (Si), manganese (Mn), magnesium (Mg), alloys thereof, and combinations thereof.

19. A separator, comprising:
a porous ceramic body, capable of conducting ions, having a first surface and a second surface opposing the first surface, wherein the porous ceramic body has a thickness in a range from about 2,000 nanometers to about 10,000 nanometers; and
a first ceramic-containing layer, capable of conducting ions, formed on the first surface of the porous ceramic body, wherein the first ceramic-containing layer is a binder-free ceramic-containing layer and has a thickness in a range from about 1 nanometer to about 1,000 nanometers; and
a second ceramic-containing layer, capable of conducting ions, formed on the second surface of the porous ceramic body, wherein the second ceramic-containing layer is a binder-free ceramic-containing layer and has a thickness in a range from about 1 nanometer to about 1,000 nanometers.

20. The separator of claim 19, wherein the porous ceramic body comprises ceramic particles dispersed in a polymeric binder.
